(19) United States
(12) Patent Application Publication
(10) Pub. No.: US 2008/0056945 A1
(43) Pub. Date: Mar. 6, 2008

(54) Stuctural Body, Chip Using The Same, And Method Of Controlling Lyophilic/Lyophobic Property

(75) Inventor: Wataru Hattori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, TOKYO (JP)

(21) Appl. No.: 11/570,675

(22) PCT Filed: Jun. 15, 2005
(86) PCT No.: PCT/JP05/10913

§ 371 Date: Dec. 14, 2006

(30) Foreign Application Priority Data
Jun. 15, 2004 (JP) 2004-177573

(51) Int. Cl. B01J 19/00

(52) U.S. Cl. 422/68.1

(57) ABSTRACT

The present invention provides a technique for precisely controlling the lyophilic/lyophobic property of a material surface using a simple construction, a method of utilizing this technique to make anisotropic the level of lyophilic or lyophobic property of a material surface having its lyophilic/lyophobic property controlled, and a method of applying the technique to retain a liquid in a predetermined region of the material surface. For example, liquid retaining portion 103 consists of a regular recess and protrusion structure, and flat part 104 consists of a flat surface surrounding the outer periphery of liquid retaining portion 103 are formed on a surface of substrate 101. The recess and protrusion structure is formed so that the surface area of recess and protrusion structure of liquid retaining portion 103 is larger than the area of the region in which liquid retaining portion 103 is formed and so that the multiplication factor of the surface area has a desired value.

### TECHNICAL FIELD

The present invention relates to a structural body, a chip using the same, and a method of controlling a lyophilic/lyophobic property.

### BACKGROUND ART

In recent years, with improved micro electro-mechanical system (MEMS) techniques, much effort has been made to develop biochips, chemical chips, micro-fluid chips, and small-sized fuel cells. These devices often handle fluids and it is thus very important to control the lyophilic or lyophobic property of a surface that is contacted by the liquid in the device. For example, controlling the liquid repellency of the surface is recognized to be very important in allowing fuel cell electrodes to last longer while maintaining high performance. The control of the lyophilic or lyophobic property has been performed by surface treatment or coating with a coat film.

For example, JP 2003-28836 A describes a method of executing surface treatment with trichlorooctadecylsilane or the like on microchannels formed in a hydrophilic glass substrate to make some of the channels hydrophobic. Further, according to JP 2003-185628 A, Teflon (registered trade mark)-containing ink is used to provide a hydrophobic area on the substrate. As for a hydrophilic area thereon, hydrophilic property is provided by coating the area with polymer and then irradiating it with UV rays.

Further, JP 2001-159618 A describes the formation, by a method such as sand blasting or a discharge process, of a fine rough surface on a cover or spacer constituting a sidewall of a cavity in a biosensor into which a liquid is introduced.

### DISCLOSURE OF THE INVENTION

However, to provide a hydrophilic or hydrophobic surface on the substrate, the techniques described in JP 2003-28836 A and JP 2003-185628 A execute surface treatment based on chemical modification, coating with a coat film, or the like on the desired surface of the substrate that is contacted by the liquid in the chip to change the material of the surface itself. Thus, for example, in such a case where the level of the lyophilic or lyophobic property is to be adjusted to a desired level, the variation of the desired level requires different surface treatments or coatings that independently implement the respective levels of lyophilic or lyophobic property. Further, the technique described in JP 2001-159618 A leaves room for improvement in the capability of adjusting the lyophilic or lyophobic property to a desired level.

With the technique utilizing surface treatment or coating, the surface obtained is generally isotropic. It is technically impossible to make anisotropic the level of lyophilic or lyophobic property of such a surface exhibiting an isotropic state.

The present invention has been made in view of the above circumstances. An object of the present invention is to provide a technique for controlling the lyophilic or lyophobic property of the surface of a material using a simple construction. In particular, the object of the present invention is to provide a technique for precisely controlling the level of lyophilic or lyophobic property of the material surface using the simple construction. Further, another object of the present invention is to provide a technique for controlling the level of lyophilic or lyophobic property of a predetermined area of the material surface and making the lyophilic or lyophobic property level anisotropic. In addition, yet another object of the present invention is to provide a technique for applying the above techniques to stably hold a liquid.

A structural body utilizing a technique for precisely controlling the level of a lyophilic/lyophobic property of a surface of a material according to the present invention is:

a structural body being formed on a surface of a chip on which a liquid is manipulated, characterized in that

the structural body being composed of a regular recess and protrusion structure formed on a surface of the chip which contacts the liquid,

wherein

when a multiplication factor of a surface area resulting from the formation of the regular recess and protrusion structure is defined as the ratio of total surface area including the surface of the regular recess and protrusion structure and the chip surface to the area of the chip in which the regular recess and protrusion structure is formed,

the multiplication factor of the surface area resulting from the formation of the regular recess and protrusion structure varies along two axial directions defined on the chip surface.

In the structural body according to the present invention, the recess and protrusion structure is formed on the surface of the chip, so that the surface area of the recess and protrusion structure increases by the area of its sides in comparison with that of a corresponding flat plane. Consequently, it provides such a construction that the surface area of the region in which the recess and protrusion structure is formed is larger than the area of this region. The ratio of surface area of the region in which the recess and protrusion structure is formed to the area of the region represents the rate of an increase in surface area resulting from the formation of the recess and protrusion structure. The ratio is called the “multiplication factor of the surface area”. According to the present invention, if the surface of the substrate constituting the recess and protrusion structure is lyophilic to a desired liquid, the surface area multiplication effect enables an increase in the level of the lyophilic property. On the other hand, if the surface of the substrate constituting the recess and protrusion structure is lyophobic to the desired liquid, the surface area multiplication effect enables an increase in the level of the lyophobic property. Further, the structural body according to the present invention is composed of the regular recess and protrusion structure. Accordingly, precisely controlling the regularity of shape, arrangement, or the like of the recess and protrusion structure makes it possible to reliably and precisely adjust the degree (level) of lyophilic/lyophobic property of the region in which the recess and protrusion structure is formed. In addition, according to the present invention, on the surface on which the regular recess and protrusion structure is formed, the multiplication factor of the surface area varies between the two axial directions. This enables the lyophilic or lyophobic property to be made anisotropic in the surface. The “multiplication factor of the surface area in the axial direction” is defined as the multiplication factor of the surface area of a fine, narrow stripe-like region extending along each of two axial directions defined on the chip surface. Specifically, given a cross section perpendicular to the surface extending along each axial direction, the “multiplication factor of the surface area in the axial direction” corresponds to a value obtained by dividing the length of a ridge along which the chip surface contacts the liquid, the length being increased by the formation of the recess and protrusion structure, by the width of the chip surface over which the recess and protrusion structure is formed.

The structural body according to the present invention is composed of the regular recess and protrusion structure and cannot be obtained simply by roughening the chip surface. Explanation will be given below of a method for forming a regular recess and protrusion structure. The term “regular recess and protrusion structure” as used in the specification means that it is constructed in such a manner that the shape, arrangement, and the like of the recess and protrusion structure have predetermined regularities and is by no means a random structure.

With the structural body according to the present invention, in particular, for the regular recess and protrusion structure formed on the surface of the chip,

a construction is preferably selected which is formed by regularly arranging a plurality of pillars being set up on the surface of the chip.

In connection with selection of the above fashion, for example, the structural body according to the present invention is preferably a structural body characterized in that

the regular recess and protrusion structure comprising the plurality of pillars formed on the surface of the chip has such a construction that a plurality of rows, each of which is composed of a plurality of truncated cone-shaped pillars of a substantially identical shape being arranged on a straight line, are arranged parallel to one another, and

in the two axial directions defined on the chip surface in directions parallel and perpendicular to the straight line,

the multiplication factor of the surface area resulting from the formation of the regular recess and protrusion structure varies along the two axial directions.

According to the present invention, when the plurality of truncated cone-shaped pillars are formed to have the substantially identical shape, by taking machining accuracy for the formation of the recess and protrusion structure into account, it means that equality in the shapes of the pillars formed are kept so that at such a case if the structural body has a lyophilic surface, the liquid is reliably retained in the region in which the recess and protrusion structure is formed, and is prevented from leaking.

In the structural body according to the present invention, such a construction may be chosen which has such a structure that a plurality of rows, each of which is composed of a plurality of truncated cone-shaped pillars of a substantially identical shape being arranged on a straight line, are arranged parallel to one another; for example, such a shape may be selected that the width of top surface of each pillar in the direction of straight line of the rows is different from that in a direction perpendicular to the straight line direction. Alternatively, such a shape may be selected that the width of bottom surface of the pillar varies between the direction parallel to the straight line and the direction perpendicular to it. In a more generalized aspect, a construction is selected in which the length of the ridge composed of the surface of the recess and protrusion structure composed of the plurality of truncated cone-shaped pillars per width both in the direction parallel to and the direction perpendicular to the straight line of the rows varies between the two axial directions. This selection makes it possible to make anisotropic the level of lyophilic or lyophobic property of the region in which the recess and protrusion structure is formed. Further, since the plurality of rows are arranged parallel to one another in each of which the plurality of truncated cone-shaped pillars of the substantially identical shape are arranged on the straight line, in such a case if the structural body has a lyophilic surface, the liquid can be more reliably retained and is inhibited from leaking to a region surrounding the outer periphery of the region in which the recess and protrusion structure is formed.

In the structural body according to the present invention, in the construction in which the plurality of rows are arranged parallel to one another in each of which the plurality of truncated cone-shaped pillars are arranged on the straight line, such a structure can be selected in which the pillars are also arranged in a straight line in the direction perpendicular to the straight line of the rows, and thus, on the whole, the pillars are set up in square grid shape.

Moreover, for the structural body according to the present invention, a shape can be selected in which in the construction in which the plurality of rows are arranged parallel to one another in each of which the pillars are arranged on the straight line,

relative positions are selected for the pillars arranged on adjacent rows so as to prevent the pillars from being aligned in a straight line in the axial direction perpendicular to the straight line. For a variation in the multiplication factor of the surface area in the axial direction perpendicular to the straight line, along the axial direction parallel to the straight line of the rows in the region in which the recess and protrusion structure composed of the plurality of pillars is formed, said selection of relative positions for the pillars prevents the multiplication factor from varying significantly. For example, in such a shape in which the pillars are also arranged in a straight line in the direction perpendicular to the straight line of the rows, and thus are arranged in square grid shape, the “multiplication factor of the surface area in the axial direction” perpendicular to the straight line is 1 on the straight line, preventing an increase in the level of the lyophilic or lyophobic property. This is because between columns in which the pillars are arranged in a straight line in the direction perpendicular to the straight line, that is, in the region between the two columns, no regularly arranged pillars are present on the straight line parallel to the columns. On the other hand, in the shape in which relative positions are selected for the pillars arranged on adjacent rows so as to prevent the pillars from being arranged in a straight line in the axial direction perpendicular to the straight line, there is substantially no probability that the “multiplication factor of the surface area in the axial direction” perpendicular to the straight line is 1. Therefore, in the case if the selection of relative positions provides the structural body with a lyophilic surface, the liquid can be more reliably retained and is inhibited from leaking to the region surrounding the outer periphery of the region in which the recess and protrusion structure being composed of the plurality of pillars is formed.

A typical example of the shape in which the relative positions are selected for the pillars arranged on adjacent rows so as to prevent the pillars from being aligned in a straight line in the axial direction perpendicular to the straight line is exemplified by such an embodiment that in the construction in which the plurality of rows, each of which is composed of a plurality of truncated cone-shaped pillars being arranged on the straight line, are arranged parallel to one another,

positions for the pillars being arranged on adjacent rows are selected in such a manner that relative positions between the pillars being arranged in different rows composes a checkered pattern arrangement. In the case If the structural body has a lyophilic surface, the selection of the checkered pattern arrangement can more reliably inhibit the liquid from leaking from the region in which the recess and protrusion structure, which is composed of the plurality of pillars being arranged in such checkered pattern form, is set up. Further, for a variation in the multiplication factor of the surface area in the axial direction perpendicular to the straight line, along the axial direction parallel to the straight line of the rows in the region in which the recess and protrusion structure, which is composed of the plurality of pillars being arranged in such checkered pattern form, is set up, the variation of the multiplication factor is reduced to lower level. In the structural body according to the present invention, such a construction may be chosen in which the plurality of pillars are arranged in zigzag shape.

According to the present invention, the above structural body according to the present invention can be utilized to control the lyophilic/lyophobic property of a predetermined region of the chip surface on which a liquid is manipulated.

For example, a type of a chip according to the present invention is

a chip used for manipulating a liquid on its surface, the chip being characterized in that:

a flow channel for the liquid is formed on the chip surface, and

at least a part of surface of the liquid flow channel is made of the structural body according to the present invention that may have the aforementioned constituent features. Another type of a chip according to the present invention is

a chip used for manipulating a liquid on its surface, the chip being characterized in that:

a plurality of reservoirs for the liquid are formed on the chip surface, and

at least a part of surface of the plurality of reservoirs is made of the structural body according to the present invention that may have the aforementioned constituent features.

Moreover, the present invention also provides a method of controlling the lyophilic/lyophobic property of a chip surface using the above structural body. That is, the method of controlling the lyophilic/lyophobic property according to the present invention is

a method of controlling a lyophilic/lyophobic property, with respect to a liquid, of a surface of at least a partial region of a surface of a chip on which the liquid is manipulated, the method being characterized in that:

the lyophilic/lyophobic property with respect to the liquid is controlled by constructing the surface of the region using the structural body that may have the aforementioned constituent features.

With the structural body according to the present invention, the level at which the region in which the recess and protrusion structure is formed is made lyophilic or lyophobic can be precisely adjusted by controlling the ratio α of total surface area of the region in which the recess and protrusion structure is constructed to the area of the region in which the recess and protrusion structure is to be formed. The ratio α meets Equation (1) described later and corresponds to a roughness factor.

A Wenzel' Equation (1) shown below relates the contact angle θ of droplets placed on a smooth solid surface to the contact angle θr of the droplets on a surface that is made of an identical chemical material to that for the smooth solid surface and has a recess and protrusion structure smaller than the droplets (“Wetting Technology Handbook” authored by Tomohiko ONDA and Yoshio ISHII and edited by Masumi KOISHI and Mitsuo KAKUTA, Technosystem, p. 25).
cos θr=α cos θ (1)
In Equation (1), α denotes a factor (roughness factor) that indicates how many times the area of a surface having a recess and protrusion structure is as large as that for a flat surface.

According to Equation (1), when a recess and protrusion structure is formed in a lyophilic or lyophobic region of which surface is made of such a material showing lyophilic or lyophobic property with the contact angle θ, in such a case that the surface area of the region is increased so as to be a times as large as that for a flat surface, the value of cosine of the contact angle θr proportional to its surface tension is increased a times. Therefore, by intentionally forming a recess and protrusion structure in a desired region on the chip surface, it is possible to increase the level of the lyophilic or lyophobic property compared to that for a flat surface. The lyophilic property refers to such a condition that it shows a contact angle of at least 0° and less than 90°. The lyophobic property refers to such a condition that it shows a contact angle of more than 90° and at most 180°.

Further, on the basis of Equation (1), in case that such a condition that the contact angles of droplets placed on a smooth surface indicates the same value is fulfilled by using a particular surface treatment or coating, the level of lyophilic or lyophobic property of a desired region can be precisely set up by variously modulating the multiplication factor α of the recess and protrusion structure intentionally formed in the region. Alternatively, under such a condition that a fixed multiplication factor α is held for the recess and protrusion structure intentionally formed in the desired region, the level of lyophilic or lyophobic property of the region can be precisely set up by modulating the contact angle θ of droplets placed on a smooth surface by using a particular surface treatment or coating.

With the present invention, for example, the intended liquid needs to contact the entire surface of the recess and protrusion structure composed of a plurality of pillars. In this case, when the surface of the recess and protrusion structure composed of the plurality of pillars is lyophobic, truncated cone-shape having a top surface part narrower than a bottom surface part is preferably chosen for the shape of the pillar. The inclination η of sidewall of the truncated cone shape having the top surface part narrower than the bottom surface part, which is defined as the angle between the bottom surface part and the sidewall, is to be η<90°. In such a case of the lyophobic surface, the contact angle of droplets placed on a smooth solid surface is 90°<θ<180°. Therefore, the inclination η of sidewall of the truncated cone-shape is preferably selected so that the sum (η+θ) of the contact angle θ of droplets and the inclination η of sidewall of the truncated cone is θ<(η+θ)≦180°.

On the other hand, when the surface of the recess and protrusion structure composed of the plurality of pillars is lyophilic, not only a truncated cone-shape having a top surface part narrower than a bottom surface part but also like a truncated cone-shape having a top surface part wider than a bottom surface part may be chosen for the shape of the pillar. The inclination η of sidewall of the truncated cone having the top surface part wider than the bottom surface part, which is defined as the angle between the bottom surface part and the sidewall, is to be 90°<η. In such a case of the lyophilic surface, the contact angle θ of droplets placed on a smooth solid surface is 0°<θ<90°. Therefore, the inclination η of sidewall of the truncated cone-shape is preferably selected so that the sum (η+θ) of the contact angle θ of droplets and the inclination η of sidewall of the truncated cone-shape having the top surface part wider than the bottom surface part is θ<(η+θ)≦180°. If the truncated cone-shape having the top surface part narrower than the bottom surface part is selected, the inclination η of sidewall of the truncated cone having the top surface part narrower than the bottom surface part, which is defined as the angle between the bottom surface part and the sidewall, is η<90°. Of course, the sum (η+θ) of the contact angle θ of droplets and the inclination η of sidewall of the truncated cone-shape will fall within the range of θ<(η+θ)≦180°.

In addition, effective aspects of the present invention include such a modification that it is executed as an arbitrary combination of the above structures, and that the expression of the present invention is converted into an invention of a method, an apparatus, or the like.

For example, in the present invention, a flow channel extending in a predetermined direction may be formed on the surface, and the liquid repelling portion may be formed in the vicinity of at least one end of the flow channel. Further, in the present invention, the liquid repelling portion may be formed from the vicinity of one end of the flow channel to the vicinity of the other end of the flow channel.

Moreover, in the present invention, a lyophilic reservoir extending in a predetermined direction may be provided on the surface, and a lyophobic region may be formed around the periphery of the reservoir. In this case, for example, the recess and protrusion structure may be subjected to such different coatings or the like so that the contact angle θ of droplets placed on a smooth surface is θ<90° for the lyophilic reservoir, and, in contrast, θ>90° for the lyophobic regions, respectively.

Further, in the present invention, the level of the lyophilic/lyophobic property of the chip surface can be adjusted by modelating the difference in height between the recess and protrusion in the recess and protrusion structure. Furthermore, in the present invention, the level of lyophilic/lyophobic property of the region in which the recess and protrusion structure is formed can be adjusted by controlling the sum of lengths of the outer peripheries of the top surfaces of the pillars in the region. These correspond to, such cases, in order to control the surface area of the liquid retaining portion or liquid repelling portion of the recess and protrusion structure, that the difference in height between the recess and protrusion is modulated, or that the length of the boundary between the recess and protrusion per unit area of the liquid retaining portion or liquid repelling portion as viewed from above the chip top surface is modulated, respectively. Application of these techniques enables the reliable control of lyophilic/lyophobic property of the desired region of the chip surface.

Furthermore, in the present invention, in a region formed on the chip surface of which surface is made of a material exhibiting a lyophilic or lyophobic property, a recess and protrusion structure is constructed on the chip surface. In this case, the rate of increase in the length of ridge of the recess and protrusion structure to the unit length for such a chip surface being flat is varied depending on the direction on the chip surface. This makes it possible to control the level of lyophilic or lyophobic property so that the level varies depending on the direction on the chip surface. The control of anisotropy based on the direction utilizes the following nature. Given surface tension that occurs when the liquid contacts the surface with the recess and protrusion structure, the length of ridge of the recess and protrusion structure along a particular direction varies depending on the direction. Thus, microscopically, the surface area contacted by the liquid varies depending on the direction. This results in a local effective variation in the roughness factor α of the above Wenzel's Equation (1) depending on the direction.

If a recess and protrusion structure is formed using a fine-processing technique, the layout is quite flexible. This makes it possible to produce, for example, an arrangement of anisotropic pillar structures or a radial recess and protrusion structure. In these structures, the rate of increase in the ridge of the recess and protrusion structure per unit length for the substrate surface being flat varies depending on the direction. Therefore, the surface tension varies depending on the direction, enabling the lyophilic or lyophobic property level to be set so that it varies depending on the direction on the chip surface.

As explained above, according to the present invention, a technique for controlling the lyophilic/lyophobic property of the material surface using the simple construction is accomplished. In this case, according to the present invention, a technique for, in controlling the lyophilic or lyophobic property of predetermined region of the material surface, making the lyophilic or lyophobic property anisotropic is attained. Moreover, according to the present invention, a technique for retaining a liquid in a predetermined region of the material surface is achieved by applying the technique controlling the lyophilic or lyophobic property of the material surface in the intended region.

### BRIEF DESCRIPTION OF THE DRAWINGS

FIG. 1 is a diagram schematically showing the construction of a structural body according to a first embodiment of the present invention;

FIG. 2 is a plan view schematically showing the construction of a chip having the structural body in FIG. 1;

FIG. 3 is a plan view schematically showing the construction of a structural body according to a second embodiment of the present invention;

FIG. 4 is a plan view schematically showing the construction of a chip according to a second embodiment of the present invention;

FIG. 5 is a plan view schematically showing a comparison of constructions of the structural bodies according to the first and second embodiments of the present invention;

FIG. 6 is a plan view schematically showing the construction of a chip according to Example 1 of the present invention;

FIG. 7 is an enlarged diagram showing the structure of a flow channel in the chip according to Example 1 of the present invention;

FIG. 8 is a graph showing a comparison of the speed at which pure water enters the flow channel with the etching depth of the flow channel according to Example 1 of the present invention varied;

FIG. 9 is a plan view showing the structure of a flow channel in a chip according to Example 2 of the present invention;

FIG. 10 is an enlarged diagram of a part of FIG. 9 enclosed by a rectangular frame;

FIG. 11 is an enlarged perspective view showing the flow channel in FIG. 9;

FIG. 12 is a sectional view schematically showing the construction of a structural body according to a third embodiment of the present invention;

FIG. 13 is a plan view schematically showing the construction of a fuel cell electrode according to a fourth embodiment of the present invention;

FIG. 14 is a diagram showing an A-A′ cross section in FIG. 13;

FIG. 15 is a sectional view schematically showing the structure of a fuel cell according to a fourth embodiment of the present invention; and

FIG. 16 is a printout of an image showing an example in which a recess and protrusion structure with a radial pattern is formed on a surface, the image being obtained by microscopically observing a central part of the recess and protrusion structure and the peripheral radial pattern.

Reference numerals shown in the figures have the following meanings.
100 Structural body
101 Substrate
102 Pillar
103 Liquid retaining portion
104 Outer peripheral part
110 Chip
111 Flow channel
112 Substrate
120 Structural body
123 Recess and protrusion structure
124 Lyophilic film
125 Lyophobic film
130 Chip
200 Electrode
201 Conductive carbon substrate
202 Structural body
203 Fluorine resin film
204 Catalyst
205 Flow channel
206 Liquid repelling portion
207 Flat portion
208 Fuel supply hole
209 Fuel exit hole

### MODE FOR CARRYING OUT THE INVENTION

The present invention utilizes a structural body formed on a surface of a chip on which a liquid is manipulated, as a technique for precisely controlling the level of lyophilic/lyophobic property of a surface of a material in the above described embodiment, specifically, as effective means for controlling the level of lyophilic/lyophobic property of the material surface so that the level indicates anisotropy within the surface. The structural body comprises a regular recess and protrusion structure formed on a surface of the chip which contacts the liquid. When a multiplication factor of a surface area resulting from the formation of the regular recess and protrusion structure is defined as the ratio of total surface area including the surface of the regular recess and protrusion structure and the chip surface to the area of the chip in which the regular recess and protrusion structure is formed, the multiplication factor of the surface area resulting from the formation of the regular recess and protrusion structure varies along two axial directions defined on the chip surface.

The above technique according to the present invention can be implemented in derivative embodiments described below, in addition to the above embodiment.

A “further embodiment of the present invention” provides a structural body characterized by comprising:

a substrate, a regular recess and protrusion structure formed on a surface of the substrate, and a flat surface that surrounds an outer periphery of the recess and protrusion structure on the surface of the substrate, wherein:

the surface area of the recess and protrusion structure is larger than the area for the recess and protrusion structure, and

the recess and protrusion structure is made more lyophilic or lyophobic than the flat surface.

In the structural body in the “further embodiment of the present invention”, the surface area of the region per unit area in which the recess and protrusion structure is formed is larger than the area of this region. Thus, if the surface of the substrate in the recess and protrusion structure is lyophilic with respect to a predetermined liquid, the lyophilic property can further be improved. If the surface of the substrate in the recess and protrusion structure is lyophobic with respect to a predetermined liquid, the lyophobic property can further be improved. Further, since the structural body according to the present invention has the regular recess and protrusion structure, controlling the regularity of shape, arrangement, or the like of the recess and protrusion structure makes it possible to reliably adjust the lyophilic or lyophobic property of the recess and protrusion structure.

A “further embodiment of the present invention” provides a structural body characterized by comprising:

a substrate, a liquid retaining portion comprising a regular recess and protrusion structure formed on a surface of the substrate, and a flat surface that surrounds an outer periphery of the liquid retaining portion on the surface of the substrate, wherein

the surface area of the recess and protrusion structure of the liquid retaining portion is larger than the area of the liquid retaining portion, and

the liquid retaining portion is made more lyophilic than the flat surface.

In the “further embodiment of the present invention”, the liquid retaining portion is a region formed on the substrate and comprises the regular recess and protrusion structure. The recess and protrusion structure makes the surface area of the liquid retaining portion larger than its area. Thus increasing the surface area of the region per its unit area makes the liquid retaining portion lyophilic with respect to a predetermined liquid. This enables the liquid retaining portion to selectively hold the liquid.

Since the structural body according to the “further embodiment of the present invention” has the recess and protrusion structure constituting the liquid retaining portion, it cannot be obtained by roughening the surface of the substrate. This feature will be described later.

In the structural body according to the “further embodiment of the present invention”, it may be constructed so that a plurality of the liquid retaining portions is formed on the surface, and thereby the liquid is retained in each of the plurality of liquid retaining portion.

In the structural body according to the present invention, the liquid retaining portion may comprise a plurality of rows arranged parallel to one another and in each of which rows a plurality of truncated cone-shaped pillars of a substantially identical shape are arranged on a straight line. The width of top surface of the pillar in an extending direction of the rows may be different from that in a direction perpendicular to the extending direction. This makes it possible to make the level of lyophilic property of the liquid retaining portion anisotropic. Further, since the plurality of rows arranged parallel to one another in each of which the plurality of truncated cone-shaped pillars of the substantially identical shape are arranged on the straight line, the liquid can be more reliably retained in the liquid retaining portion and thus inhibited from leaking to the flat surface surrounding the outer periphery of the liquid retaining portion.

In the “further embodiment of the present invention”, the plurality of truncated cones having the substantially identical shape means that the liquid is reliably retained in the liquid retaining portion, maintaining the identity of shapes of the pillars so as to prevent the liquid from leaking from a particular place.

In the structural body according to the “further embodiment of the present invention”, the ratio of length of the ridge of the recess and protrusion structure of the liquid retaining portion to the width of the liquid retaining portion may vary among a plurality of cross sections of the liquid retaining portion perpendicular to the flat surface. This enables the liquid retaining portion to be made lyophilic in the direction of a cross section with a higher ratio. Therefore, this makes it possible to reliably make the level of lyophilic property of the liquid retaining portion anisotropic.

In the structural body according to the “further embodiment of the present invention”, a flow channel extending in a predetermined direction may be formed on the surface, and the liquid retaining portion may be formed in the vicinity of at least one end of the flow channel. This enables the liquid to be reliably introduced through one end of the flow channel and retained in the flow channel.

In the structural body according to the “further embodiment of the present invention”, the liquid retaining portion may be formed from the vicinity of one end of the flow channel to the vicinity of the other end of the flow channel. This enables the liquid to be reliably retained throughout the flow channel.

In the structural body according to the “further embodiment of the present invention”, the liquid retaining portion comprises a plurality of rows arranged parallel to one another in each of which a plurality of truncated cone-shaped pillars of the substantially identical shape are arranged along the extending direction of the flow channel. The length of ridge of the recess and protrusion structure in a cross section that is parallel to the extending direction of the rows and perpendicular to the flat surface with respect to the length of the liquid retaining portion in the cross section is larger than the length of ridge of the recess and protrusion structure in a different cross section perpendicular to the flat surface respect to the length of the liquid retaining portion in the different cross section. This enables the lyophilic property of the liquid retaining portion to be made anisotropic. In the specification, the above direction is parallel to the extending direction of the flow channel. This enables the structure to be made more lyophilic in the extending direction of the flow channel. This in turn enables the liquid to be reliably retained in the flow channel and inhibited from leaking sideways. In the “further embodiment of the present invention”, the length of the ridge refers to the length of sectional contour of the recess and protrusion structure in a predetermined cross section. Further, in the “further embodiment of the present invention”, the width of top surface of the pillar in the extending direction of the rows may be larger than that in a direction perpendicular to the extending direction.

In the structural body according to the “further embodiment of the present invention”, the plurality of pillars may be arranged in checkered pattern form. This makes it possible to further reliably inhibit the liquid from leaking from the liquid retaining portion. In the structural body according to the “further embodiment of the present invention”, such a construction may be chosen in which the plurality of pillars are arranged in zigzag shape.

In the structural body according to the “further embodiment of the present invention”, the liquid retaining portion may be configured so that the product a cos θ of the ratio α of surface area of the recess and protrusion structure of the liquid retaining portion to the area of the liquid retaining portion and the contact angle θ at which the predetermined liquid contacts the flat surface meets:
|α cos θ|>1.

This enables the stable manufacture of a super-lyophilic liquid retaining portion. In the present invention, the flat surface may be composed of the same material as that of the recess and protrusion structure.

In the “further embodiment of the present invention”, the interval of the plurality of pillars along the outer periphery of the bottom surface in the perpendicular direction may be smaller than the width of top surface of the pillar is in the perpendicular direction. This enables the surface area of the liquid retaining portion to be made sufficiently larger than that for a flat surface.

A “further embodiment of the present invention” provides a structural body characterized by comprising:

a substrate, a liquid repelling portion comprising a regular recess and protrusion structure formed on a surface of the substrate, and a flat surface that surrounds an outer periphery of the liquid repelling portion on the surface of the substrate, and in that:

the surface area of the recess and protrusion structure of the liquid repelling portion is larger than the area of the liquid repelling portion, and the liquid repelling portion is made more lyophobic than the flat surface.

The liquid repelling portion is a region formed on the substrate and comprises the regular recess and protrusion structure. The recess and protrusion structure makes the surface area of the liquid repelling portion larger than its area. Thus increasing the surface area of the region per its unit area makes the liquid repelling portion lyophobic than the flat surface with respect to a predetermined liquid. This enables the liquid to be selectively excluded from the liquid repelling portion.

Since the structural body according to the “further embodiment of the present invention” has the recess and protrusion structure constituting the liquid repelling portion, it cannot be obtained by roughening the surface of the substrate. This will be described later.

In the structural body according to the “further embodiment of the present invention”, the liquid repelling portion comprises a plurality of rows arranged parallel to one another in each of which a plurality of pillars of a substantially identical shape are arranged along a predetermined direction. The length of ridge of the recess and protrusion structure in a cross section that is parallel to the extending direction of the rows and perpendicular to the flat surface with respect to the length of the liquid repelling portion in the cross section is larger than the length of ridge of the recess and protrusion structure in a different cross section perpendicular to the flat surface respect to the length of the liquid retaining portion in the different cross section. This enables the level of the lyophilic property of the liquid repelling portion to be made anisotropic. Further, when the plurality of rows are arranged parallel to one another in each of which the plurality of pillars of the substantially identical shape are arranged on a straight line, the liquid can be more reliably retained in the liquid repelling portion and thus inhibited from leaking to the flat surface surrounding the outer periphery of the liquid repelling portion.

In the “further embodiment of the present invention”, the plurality of pillars having the substantially identical shape means that the identity of shapes of the pillars is maintained so as to prevent the liquid from leaking from the flat part to the liquid repelling portion in a particular place. In the present invention, the pillars may be in an anchor base shape.

In the structural body according to the “further embodiment of the present invention”, the liquid repelling portion may be configured so that the product a cos θ of the ratio α of surface area of the recess and protrusion structure of the liquid repelling portion to the area of the liquid repelling portion and the contact angle θ at which the predetermined liquid contacts the flat surface meets:
|α cos θ|>1.
This enables the stable manufacture of a super-liquid-repellent liquid repelling portion. In the “further embodiment of the present invention”, the flat surface may be composed of the same material as that of the recess and protrusion structure.

The “further embodiment of the present invention” provides a chip characterized by comprising a flow channel comprising the above structural body.

Further, the “further embodiment of the present invention” provides a chip characterized by comprising a plurality of reservoirs comprising the above structural body.

Furthermore, the “further embodiment of the present invention” provides a method of controlling the lyophilic property, characterized by controlling the lyophilic/lyophobic property of the above surface of the substrate using the above structural body.

According to the present invention, the level of lyophilic property of the liquid retaining portion can be controlled by controlling the ratio α of surface area of the recess and protrusion structure of the liquid retaining portion to the area of the liquid retaining portion. The ratio α meets Equation (1), described above, and corresponds to the roughness factor.

Embodiments of the present invention will be described below with reference to the drawings. In all the drawings, common components are denoted by the same reference numerals with their descriptions appropriately omitted.

### FIRST EMBODIMENT

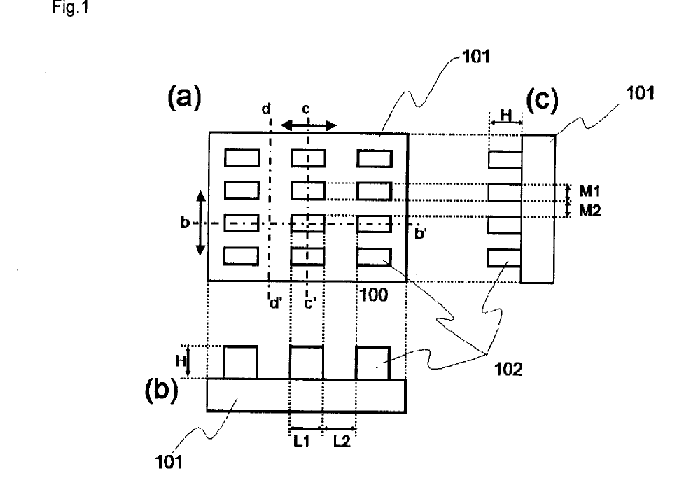

FIG. 1 is a drawing schematically illustrating the construction of a structural body according to the embodiment of the present invention. FIGS. 1(a) to 1(c) are views schematically showing the construction of structural body 100. FIG. 1(a) is a plan view of structural body 100. FIG. 1(b) is a front sectional view taken along an alternate long and short dash line b-b′ in FIG. 1(a). FIG. 1(c) is a side sectional view taken along an alternate long and short dash line c-c′ in FIG. 1(a).

As shown in FIGS. 1(a) to 1(c), structural body 100 comprises liquid retaining portion 103 formed on a surface of substrate 101 and outer peripheral part 104 consisting of a flat surface surrounding the outer periphery of liquid retaining portion 103.

Liquid retaining portion 103 consists of a regular recess and protrusion structure formed on the surface of substrate 101. Structural body 100 has plural square pole-like pillars 102 provided on substrate 101 to constitute the regular recess and protrusion structure. Plural pillars 102 are plural truncated cones of a substantially identical shape and are arranged in a grid in the same orientation. Here, the plural truncated cones having the substantially identical shape means that the pillars have the identical shape such that a liquid is retained in liquid retaining portion 103 without leaking from a particular region. Further, pillars 102 may be shaped like, for example, truncated pyramids, circular truncated cones, or elliptic truncated cones. The corners of the truncated cone may be rounded.

The surface area of liquid retaining portion 103 is larger than the area of the region in which liquid retaining portion 103 is formed. Liquid retaining portion 103 is made more lyophilic than outer peripheral part 104. Thus, structural body 100 is simple and can be easily and stably manufactured. Structural body 100 also enables liquid retaining portion 103 to be selectively made lyophilic to reliably retain a liquid.

The level of lyophilic or lyophobic property of liquid retaining portion 103 can be controlled by controlling ratio α of the surface area of recess and protrusion structure of liquid retaining portion 103 to the area of the region in which liquid retaining portion 103 is formed. Increasing ratio α makes it possible to make liquid retaining portion 103 more lyophilic. This enables liquid retaining portion 103 to selectively retain the liquid. Ratio α of the surface area is a roughness factor α in a Wenzel's expression, that is, the following expression (1) described above and a factor that indicates how many times the area of a surface having a recess and protrusion structure is as large as that for a flat surface.
cos θr=α cos θ (1)

In Equation (1), θ denotes the contact angle of droplets of a predetermined liquid placed on a flat surface consisting of the same material as that of liquid retaining portion 103. Further, θr denotes the contact angle of the droplets placed on liquid retaining portion 103 consisting of a recess and protrusion structure. In this case, θ denotes the contact angle of the droplets in the outer peripheral part 104.

For example, as means for obtaining a “super-lyophilic” or “super-lyophobic” surface, the present invention sets ratio α=ΣSi/S for contact angle θ of the target liquid on a flat surface so as to meet:

α cos θ>0.98, corresponding to a condition for achieving the “super-lyophilic property”, which exhibits θr<10°, that is, cos θα>0.98, and

α cos θ<−0.98, corresponding to a condition for achieving the “super-lyophobic property”, which exhibits θr>170°, that is, cos θα<−0.98,

on the basis of Equation (1): cos θr=α cos θ (1) which is deduced from an “approximate” relation of S·cos θr=(ΣSi)·cos θ (0),

with respect to an effective contact angle θr

where the relation involves ratio α=ΣSi/S of apparent surface area “S” to surface area “ΣSi” of an actual surface having a recess and protrusion structure, contact angle θ of a target liquid on a flat surface, and effective contact angle θr of the target liquid on the actual surface having the recess and protrusion structure. In particular, the above α and θ more preferably meet: |α cos θ|>1 (2),

which is a criterion exceeding the above boundary condition:

α cos θ>0.98 and

α cos θ<−0.98, that is, |α cos θ|>0.98.

For example, in the recess and protrusion structure formed in structural body 100, shown in FIGS. 1(a) to 1(c), apparent surface area “S” is {(L1+L2)×(M1+M2)}, and surface area “ΣSi” of the actual surface having the recess and protrusion structure is {(L1+L2)×(M1+M2)+2×(M1+L1)×H}. For ratio α=ΣSi/S, α={(L1+L2)×(M1+M2)+2×(M1+L1)×H}/{(L1+L2)×(M1+M2)}=1+{2×(M1+L1)×H}/{(L1+L2)×(M1+M2)}. Multiplication factor α can be adjusted to a desired value by regulating the size of structural body 100; M1, L1, and H and their arrangement interval; and M2 and L2. In this case, for example, a semiconductor fine-processing technique makes it possible to obtain a precise and large H value by increasing etching depth. Further, values L1, L2, M1, and M2 can be precisely controlled by changing a mask layout for lithography.

Setting the absolute value of α cos θ larger than 1 enables liquid retaining portion 103 to be made super-lyophilic or super-lyophobic. Thus, when liquid retaining portion 103, formed on the surface of substrate 101 that is lyophilic to a predetermined liquid, meets Equation (2), liquid retaining portion 103 can be made super-lyophilic. This enables the liquid to be reliably retained in liquid retaining portion 103, consisting of the recess and protrusion structure.

Liquid retaining portion 103 and outer peripheral part 104 are normally formed of an identical chemical substance. However, for example, the surface of outer peripheral part 104 may be lyophobic. Alternatively, the surface of outer peripheral part 104 may be composed of a liquid repelling chemical substance. This makes it possible to more reliably inhibit the liquid from leaking from liquid retaining portion 103.

Now, description will be given of a method for manufacturing structural body 100, shown in FIGS. 1(a) to 1(c). Possible materials for substrate 101 include silicon, glass, quartz, any of various plastic materials, and an elastic material such as rubber. Structural body 100 can be obtained by simultaneously forming a recess and protrusion structure by a lithography technique and etching techniques that are used to fine-process substrate 101. This requires compatibility with these process techniques and the precise control of ratio α of surface area of liquid retaining portion 103 of the recess and protrusion structure to the area of liquid retaining portion 103.

A difference in height between the recess and protrusion in liquid retaining portion 103 can be varied by controlling the etching depth during an etching step such as dry etching; an identical pattern may be formed at a lithography step such as photolithography, electron beam lithography, or nanoimprint for forming a resist pattern. Thus, structural body 100 is compatible with the process techniques and enables the precise control of rate of increase in surface area resulting from the recess and protrusion structure. Further, this technique is suitable, for example, for controlling the level of the lyophilic or lyophobic property for each substrate 101.

Further, in the lithography step, the surface area of the recess and protrusion structure of liquid retaining portion 103 can be precisely controlled by varying a pattern to be formed to vary the length of the boundary between the recess and protrusion per unit surface area as viewed from above the substrate top surface. In this case, even with the identical etching depth during the subsequent etching step such as dry etching, a different pattern to be formed makes it possible to vary the ratio of surface area of liquid retaining portion 103 to the area of the region in which liquid retaining portion 103 is formed. This enables the rate of increase in surface area to be simultaneously varied during one etching step for each region of the identical substrate. Consequently, this technique can be preferably used for controlling the level of the lyophilic or lyophobic property for each region of the identical substrate.

Further, the method for manufacturing structural body 100 may be embossing. This technique uses a mold with both difference in height and pattern varied to enable the rate of increase in surface area to be varied for each region of the identical substrate 101. Consequently, the technique can be preferably used for controlling the level of the lyophilic or lyophobic property for each region of the identical substrate.

Structural body 100 can be obtained by, for example, forming a resist pattern corresponding to the configuration of pillars 102 arranged on the surface of substrate 101 and then etching the surface of substrate 101. Alternatively, if substrate 101 is made of silicon, the resist may be removed after etching and the surface may be oxidized at a high temperature that is, for example, equal to or higher than 850° C. to form a silicon oxide film all over the surface of substrate 101. Forming the silicon oxide film enables the surface of substrate 101 hydrophilic. This makes it possible to make the substrate more lyophilic on the basis of the formation of the recess and protrusion structure. Water can thus be reliably retained.

However, liquid retaining portion 103 of structural body 100 has a special recess and protrusion shape that meets conditions for retaining the liquid. Accordingly, such a recess and protrusion structure needs to be formed on substrate 101. Thus, it is difficult to obtain structural body 100 simply by roughening the surface of substrate 101 or forming plural pillars 102 on substrate 101.

In structural body 100, pillars 102 have a large surface area and are closely arranged within the region of liquid retaining portion 103. This makes sufficiently lyophilic liquid retaining portion 103, consisting of the recess and protrusion structure, to reliably retain the liquid. Specifically, in the form of pillars 102 shown in FIG. 1(a), interval (M2, L2) of plural pillars 102 along the outer periphery of bottom surface of pillar is smaller than width (M1, L1) of bottom surface of pillar 102. Further, sum (2×(M1+L1)) of lengths of the outer peripheries of the top surfaces of pillars 102 of liquid retaining portion 103 is controlled so that sum (2×(M1+L1)) is sufficiently large. Further, the following is controlled so that the ratio of the length of the ridge ((M1+M2+2×H) and (L1+L2+2×H)) of the recess and protrusion structure to width ((M1+M2) and (L1+L2)) of the recess and protrusion structure is sufficiently large: the length ((M1+M2+2×H)/(M1+M2) and (L1+L2+2×H)/(L1+L2)) of ridge of the recess and protrusion structure per unit length, that is, the length of ridge of the sectional curve of liquid retaining portion 103 in a predetermined direction. Further, ratio α of surface area of liquid retaining portion 103, consisting of the recess and protrusion structure, to the area of liquid retaining portion 103 is increased so that the absolute value of α cos θ, described above, exceeds 1.

Specifically, pillars 102 are configured and arranged as follows. In FIGS. 1(a) to 1(c), longitudinal width L1 of pillar 102 may be, for example, at least 0.01 μm and at most 50 μm. Longitudinal gap width L2 of bottom surface of pillar 102 may be at least 0.01 μm and at most 50 μm. Further, latitudinal width M1 of pillar 102 may be, for example, at least 0.01 μm and at most 50 μm. Latitudinal gap width M2 of bottom surface of pillar 102 may be at least 0.01 μm and at most 50 μm. Furthermore, height H of pillar 102 may be at least 0.01 μm and at most 50 μm.

In structural body 100, shown in FIGS. 1(a) to 1(c), the formation of the recess and protrusion structure on the surface with pillars 102 increases the surface area of liquid retaining portion 103 compared to that obtained if the surface of substrate 101 is flat. For example, the liquid retaining portion 103 is a region that is 20 μm in length and 45 μm in width. Pillar 102 is a rectangular parallelepiped that is 2.5 μm in length M1, 7.5 μm in width, and 5 μm in height. Further, 4×3=12 pillars 102 are arranged in the appropriate region. Then, the surface area of substrate 101 in liquid retaining portion 103 is α=1+{12×(2.5+7.5)×2×5}/(20×45)≈2.3; the surface area is 2.3 times as large as that of a corresponding flat surface. In this construction, if substrate 101 is composed of a material that exhibits a contact angle θ of 65° for a flat surface, the multiplying effect of the recess and protrusion structure on the surface area reduces the contact angle θr to 9.5°, which corresponds to a very high lyophilic property.

Further, in this case, if substrate 101 is composed of a material that exhibits a contact angle θ of 300 for a flat surface,
α cos θ=2.02>1.
Thus, structural body 100, shown in FIGS. 1(a) to 1(c), allows the absolute value of α cos θ to exceed 1. This enables the liquid retaining portion 103 to be made super-lyophilic, for example, super-hydrophilic. The liquid can thus be reliably retained in the liquid retaining portion 103, consisting of the recess and protrusion structure. Structural body 100 can be preferably used as a structural body in which liquid retaining portion 103 serves as a reservoir.

Further, the lyophilic property of liquid retaining portion 103 may vary depending on the direction. For example, as shown in FIG. 1, plural rows may be arranged parallel to one another in each of which plural pillars 102 of a substantially identical shape are arranged on a straight line. Furthermore, the width of top surface of the pillar 102 in an extending direction of the rows may be different from that in a direction perpendicular to the extending direction. In FIG. 1, the width of top surface of the pillar 102 in the lateral direction of FIG. 1, that is, in the extending direction of the rows, is different from that in the vertical direction of the figure.

Further, the lyophilic property of liquid retaining portion 103 may be made anisotropic by disposing pillars 102 so that the length of ridge of the above sectional curve in the extending direction of the rows of pillars 102 is different from that in the direction perpendicular to the extending direction.

Now, the effects of structural body 100, shown in FIG. 1, will be described.

Structural body 100, shown in FIG. 1, can be formed in a predetermined region by using a fine-processing technique for producing chips or the like. Thus, structural body 100 can be easily and stably manufactured. The lyophilic or lyophobic property of surface of substrate 101 can be precisely controlled by a method compatible with the chip producing technique. The liquid can be stably retained in the liquid retaining portion 103.

Further, structural body 100 enables the lyophilic or lyophobic property of surface of substrate 101 to be precisely controlled using a simple construction. For example, even if the entire surface of substrate 101 is subjected to an identical surface treatment or coating, a region with a surface exhibiting different lyophilic or lyophobic property levels may be formed on the substrate 101 by adjusting the difference in height, the pitch of steps, or the like in the recess and protrusion structure formed on structural body 100.

First, in the recess and protrusion structure formed on structural body 100, on a cross section shown by an alternate long and short dash line b-b′ in FIG. 1(a), the rate of increase in the length of ridge of the recess and protrusion structure per unit length for a flat substrate surface is (L1+L2+2×H)/(L1+L2). The application of size: L1+L2=(45/3) μm, width L1: 7.5 μm, and height H: 5 μm, shown above, results in (L1+L2+2×H)/(L1+L2)=(15+10)/15=1.67. On the other hand, on a cross section shown by an alternate long and short dash line c-c′ in FIG. 1(a), the rate of increase in the length of ridge of the recess and protrusion structure per unit length for a flat substrate surface is (M1+M2+2×H)/(M1+M2). The application of size: M1+M2=(20/4) μm, length M1: 12.5 μm, and height H: 5 μm, shown above, results in (M1+M2+2×H)/(M1+M2)=(5+10)/5=3. Therefore, in the recess and protrusion structure formed on structural body 100, the rate of increase in the length of ridge of the recess and protrusion structure per unit length for a flat substrate surface varies depending on the direction in the recess and protrusion structure. Correspondingly, when the liquid contacts the surface having the recess and protrusion structure formed on structural body 100, the resulting surface tension increases by a factor of about 1.67 in the vertical direction, shown by the alternate long and short dash line b-b′, and by a factor of 3 in the lateral direction, shown by the alternate long and short dash line c-c′. Consequently, on the substrate surface having the recess and protrusion structure, the level of the lyophilic or lyophobic property in the vertical direction can be set to be different from that in the lateral direction.

That is, multiplication factor α of the surface area obtained by averaging over the entire surface having the recess and protrusion structure shown in FIG. 1(a) is α=1+{2×(M1+L1)×H}/{(L1+L2)×(M1+M2)}. However, multiplication factor α_{T} of the local surface area in the vertical direction (vertical axis direction), shown by the alternate long and short dash line b-b′, is generally equal to the rate of increase in the length of the ridge in that axial direction; multiplication factor α_{T} can be expressed by α_{T}≈1+(2×H)/(M1+M2). Multiplication factor α_{L} of the local surface area in the lateral direction (horizontal axis direction), shown by the alternate long and short dash line c-c′, is generally equal to the rate of increase in the length of the ridge in that axial direction; multiplication factor α_{L} can be expressed by α_{L}≈1+(2×H)/(L1+L2). For example, when height H of pillar 102, constituting the regular recess and protrusion structure, is fixed and the arrangement pattern of pillars 102 is selected to be (L1+L2)>(M1+M2), then α_{T}>α_{L}. Effective multiplication factors α_{T} and α_{L} of the surface areas along the two axial directions can thus be made different from each other. In this case, it is desirable that generally average multiplication factor α of the surface area and the effective multiplication factors α_{T} and α_{L} of the surface areas along the two axial directions meet the relationship α_{T}>α>α_{L}. To select (L1+L2)>(M1+M2), it is desirable that the condition (L1+L2)>(M1+L1)>(M1+M2), that is, the condition L2>M1 and L1>M2, is met. Further, as described above, in the form of pillars 102 shown in FIG. 1(a), it is preferable that interval (M2, L2) of plural pillars 102 along the bottom surface outer periphery is smaller than width (M1, L1) of bottom surface of pillar 102 in a predetermined direction parallel to outer peripheral part 104, that is, M1>M2 and L1>L2. To meet the condition L1>L2>M1>M2 in order to meet the above two requirements, it is preferable that L1, L2, M1, and M2 are selected which define the shape and arrangement of pillars 102 constituting the regular recess and protrusion structure.

To select L1>L2 and M1>M2, desirably, ratios L1/L2 and M1/M2 are normally selected to be 10≧(L1/L2)>1 and 10≧(M1/M2)>1, preferably 5≧(L1/L2)>1 and 5≧(M1/M2)>1. Further, to select values so as to meet the condition L1>L2>M1>M2, desirably, ratio L2/M2 is normally selected to be 10≧(L2/M2)>1, preferably 5≧(L2/M2)>1.

With the conventional techniques described in JP 2003-28836 A, JP 2003-185628 A, and JP 2001-159618 A, described above, the lyophilic or lyophobic property of the material surface is uniquely determined by a change of the material of the surface and is isotropic on the substrate surface. It is thus difficult to achieve an anisotropic lyophilic or lyophobic property that is more significant in one direction. In contrast, the present embodiment makes it possible to vary the level of the lyophilic or lyophobic property among the regions of the substrate surface in the chip using the same surface processing and coating. The present embodiment can also easily provide a structure with a lyophilic or lyophobic property varying with the direction. Further, the structure with the anisotropic lyophilic or lyophobic property can reliably control the level of the lyophilic or lyophobic property in a predetermined direction. This makes it possible to stably obtain liquid retaining portion 103 with an anisotropic lyophilic property level using the simple construction.

Further, in structural body 100, the lyophilic property of pillar 102 in its longitudinal direction (lateral direction of the figure) is designed to be more significant than that in its latitudinal direction (vertical direction of the figure). Consequently, the level of the lyophilic property in the liquid retaining portion 103 is anisotropic, reliably inhibiting a solution from leaking in the latitudinal direction of the pillar 102. Thus, if plural structural bodies 100 are provided on one substrate 101, the degree of integration in the latitudinal direction can be improved.

Structural body 100, shown in FIGS. 1(a) to 1(c), can be used as, for example, a reservoir or flow channel, by providing structural body 100 on the substrate of the chip. In the present embodiment, description of an example in which structural body 100 is applied to a reservoir will be given below. A detailed description of a construction in which structural body 100 is applied to a flow channel will be given in examples described below.

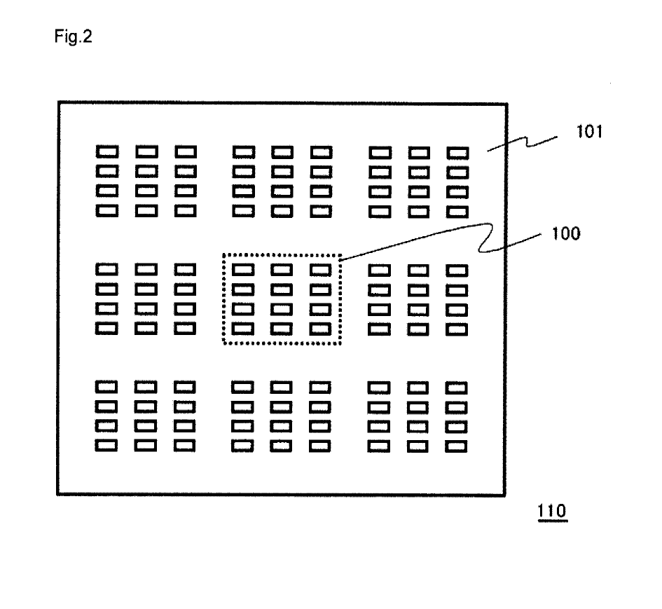

FIG. 2 is a plan view schematically showing the construction of a chip having structural body 100 shown in FIG. 1. Chip 110 shown in FIG. 2 has plural arrays of plural structural bodies 100 formed on a surface of substrate 101. Structural body 100 is a region shown by a dot line in the figure.

In this construction, liquid retaining portion 103 in each structural body 100 is a region that is more lyophilic than outer peripheral part 104 consisting of a flat substrate 101 surface surrounding the outer periphery of liquid retaining portion 103. The liquid is retained in liquid retaining portion 103 and its vicinity. Thus, chip 110 is configured so that plural liquid retaining portions 103 are formed on the surface of substrate 101 and so that the liquid is retained in each of liquid retaining portions 103.

Chip 110, shown in FIG. 2, can be formed by the method for producing structural body 100 shown in FIG. 1. Specifically, for example, the above fine-processing technique is used for the formation.

Chip 110, shown in FIG. 2, can be preferably used as an inspection chip such as a DNA chip. In the configuration in which plural structural bodies 100 are arranged in a plane, the gap width between reservoirs in the vertical direction is often different from that in the lateral direction. Consequently, the margin with which a liquid dropped into the reservoir spreads out from the region of the reservoir in the vertical direction is different from that in the lateral direction. In this case, a variation in lyophilic property between the vertical and lateral directions enables the margin of the spread to be effectively used. This makes it possible to design the maximum amount of liquid that can be dropped into the reservoirs.

If water or a buffer is retained in structural body 100, shown in FIG. 1, or liquid retaining portion 103 of chip 110, shown in FIG. 2, the surface of substrate 101 on which pillar 102 are formed can be coated in order to prevent molecules of DNA or protein from sticking to the surface of substrate 101. Possible coating materials include, for example, substances having a structure similar to that of phosphatide constituting cell membranes. Further, molecules of DNA or the like can be prevented from sticking to the surface of substrate 101 by coating the surface of substrate 101 with a water-repellent resin such as a fluorine-containing resin or a hydrophilic substance such as cow serum albumin. Alternatively, the surface of substrate 101 may be coated with a hydrophilic polymer material such as MPC (2-methacryloyloxyethylphosphorylcholine) polymer or a hydrophilic silane coupling agent.

To make the surface of substrate 101 hydrophilic using an MPC polymer, specifically, for example, Ripijure (registered trade mark; manufactured by NOF CORPORATION) may be used. If the Ripijure (registered trade mark) is used, coating can be carried out by dissolving it in a TBE (trisborate+EDTA) buffer or the like so that the resulting solution contains 0.5 wt % of ripijure, filling the surface of substrate 101 on which pillars 102 are formed, with the solution, and leaving substrate 101 as it is for several minutes.

The hydrophilic surface of substrate 101e enables the liquid to be reliably introduced into liquid retaining portion 103 utilizing not only the lyophilic or lyophobic property resulting from the formation of the recess and protrusion structure but also a capillary phenomenon. Possible methods for making the surface of substrate 101 hydrophilic include the method of forming a hydrophilic film such as silicon oxide film as described above. Alternatively, at least the surface of substrate 101 may be constructed using a hydrophilic polymer material such as PHEMA (polyhydroxyethylmethacrylate). This makes it possible to inhibit a sample component from being non-specifically adsorbed to the surface of substrate 101. Thus, even a slight amount of sample enables a predetermined manipulation such as analysis to be reliably achieved. Alternatively, the surface of substrate 101 may be constructed using titanium oxide and irradiated with ultraviolet rays so as to be hydrophilic the surface of substrate 101. Alternatively, the surface of substrate 101 may be ashed by oxygen plasma.

### SECOND EMBODIMENT

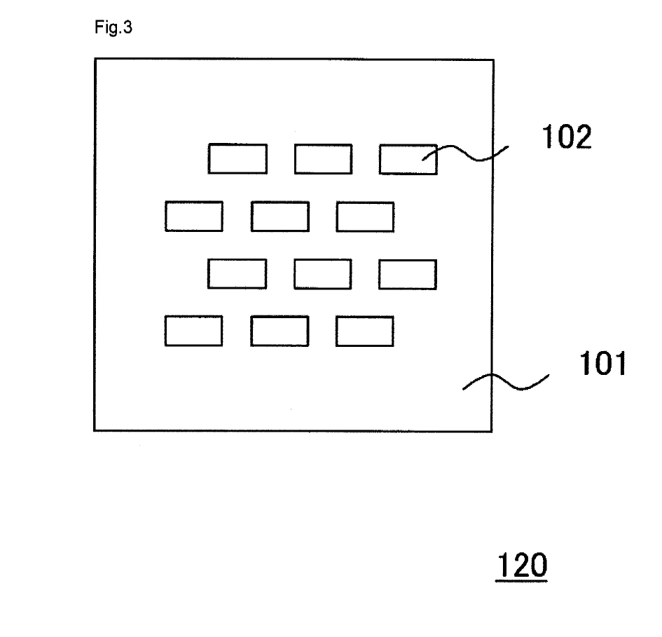

In the present embodiment, differences from the first embodiment will mainly be described. FIG. 3 is a plan view schematically showing the construction of structural body 120 according to the present embodiment. Structural body 120 is constructed to have plural rows arranged in parallel in each of which plural pillars 102 are arranged on a straight line. Two adjacent rows are arranged in a checkered pattern form in which the recesses and protrusions in the recess and protrusion structures are staggered. In the latitudinal direction of pillars 102, plural pillars 102 are arranged in a zigzag so as to prevent groove portions formed between pillars 102 from being arranged on a straight line.

For example, in the grid-like arrangement in FIG. 1(a), when the leading end of the liquid reaches the position shown by segment d-d′, it does not contact any of pillars 102. When the leading end of the liquid reaches the position shown by segment d-d′, the contact angle observed in this condition is substantially equal to the contact angle θ observed in a flat part. On the other hand, when the leading end of the liquid is present at the position shown by segment c-c′, it contacts many pillars 102 arranged in a line. In this case, the contact angle observed at the leading end of the liquid present at the position shown by segment c-c′ is substantially equal to the effective contact angle Or in the recess and protrusion structure. That is, in the recess and protrusion structure composed of pillars 102 arranged in grid form as shown in FIG. 1(a), the contact angle of the liquid leading end varies significantly when observed locally. In other words, the grid-like arrangement may result in the local unevenness of lyophilic property.

On the other hand, in the checkered pattern arrangement shown in FIG. 3, it is very rare that the liquid leading end does not contact any of pillars 102 as is the case with the position shown by segment d-d′ in FIG. 1(a). Therefore, although the number of pillars 102 that are contacted by the liquid leading end varies slightly depending on the position, the locally observed effective contact angle is generally equal to the effective contact angle θr in the recess and protrusion structure. In other words, in the checkered pattern arrangement shown in FIG. 3 sharply reduces the possibility of local unevenness of the lyophilic property.

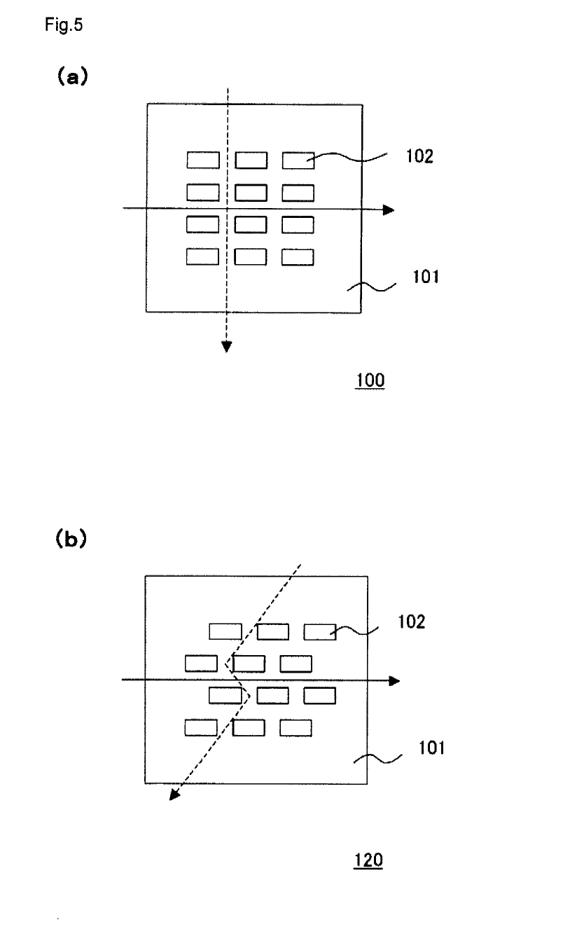

Thus, structural body 120, shown in FIG. 3, exerts not only the effects of structural body 100 (FIG. 1), described in the first embodiment, but also the following effects. FIGS. 5(a) and 5(b) illustrate a comparison of structural body 100 shown in FIG. 1, with structural body 120 shown in FIG. 3. As shown in FIG. 5(b), structural body 120 in which pillars 102 are arranged in checkered pattern form, adjacent pillars 102 are arranged to overlap with each other in the latitudinal direction (vertical direction of the figure) of pillars 102 so as to avoid forming a linear groove in the latitudinal direction. Thus, in this configuration, in contrast to the configuration shown in FIG. 5(a) in which pillars 102 are arranged in grid form, the liquid is more reliably inhibited from leaking from liquid retaining portion 103 in the latitudinal direction (vertical direction of the figure).

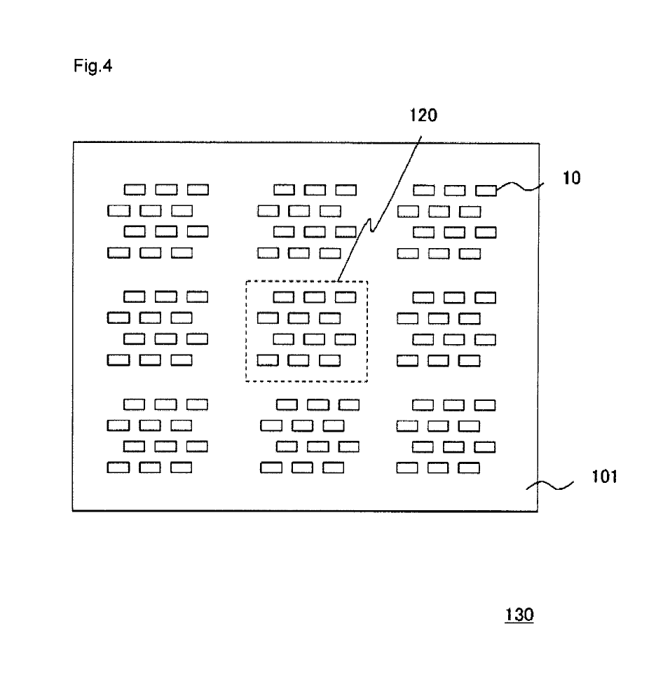

FIG. 4 is a plan view schematically showing the construction of a chip having structural body 120 shown in FIG. 3. Chip 130 shown in FIG. 4 is composed of a plurality of arrays each of a plurality of structural bodies 120. In chip 130, the predetermined liquid can be reliably retained in liquid retaining portions 103 of plural structural bodies 120 arranged in a plane.

### THIRD EMBODIMENT

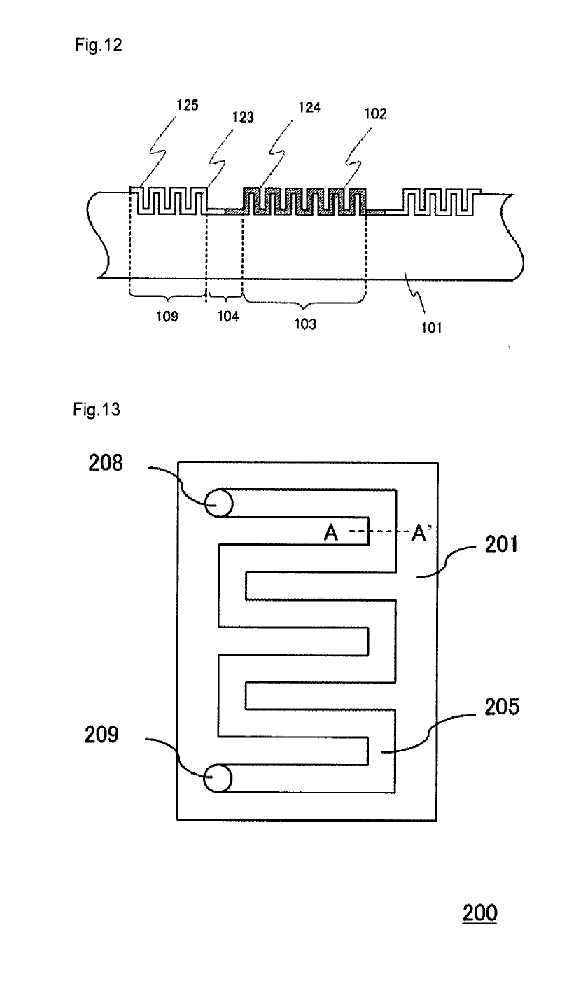

A liquid repelling portion surrounding the outer periphery of flat part 104 may further be formed in the structural bodies described in the first and second embodiments. FIG. 12 is a sectional view schematically showing the construction of the structural body according to the present embodiment.

In the structural body shown in FIG. 12, the surface of liquid retaining portion 103 is covered with lyophilic film 124 that is a surface coating film. Further, a side of surface of flat part 104 which is adjacent to liquid retaining portion 108 is covered with lyophilic film 124. A side of surface of flat part 104 which is adjacent to lyophobic part 109 is covered with liquid repelling film 125. This enables a sample solution to be reliably retained in liquid retaining portion 108 and inhibited from leaking to outside the region in which the lyophilic film 124 is formed.

Further, lyophobic part 109 is formed to surround the outer periphery of flat part 104. Lyophobic part 109 consists of recess and protrusion structure 123 and is less compatible with the liquid sample. The surface of lyophobic part 109 is covered with liquid repelling film 125 that is a surface coating film.

The structural body having a sectional structure shown in FIG. 12 has outer peripheral part 104 consists of a flat surface and lyophobic part 109 formed in this order along the outer periphery of liquid retaining portion 103. This enables the liquid to be reliably retained in liquid retaining portion 103 and inhibited from leaking. This structural body is preferably used for, for example, a reservoir or flow channel.

Equations (1) and (2) shown above are also applicable to lyophobic part 109. Controlling the surface area of recess and protrusion structure 123 enables the level of the lyophobic property to be adjusted. Further, |α cos θ|>1 enables lyophobic part 109 to be super-lyophobic.

In the above embodiment, the recess and protrusion structure is formed so that the flat surface forms the lyophilic liquid retaining portion. However, a structural body having a liquid repelling portion consisting of a recess and protrusion structure can be obtained by providing the recess and protrusion structure on the surface of a substrate that is lyophobic to a predetermined liquid. In this case, the liquid can be selectively held on the flat surface surrounding the outer periphery of the lyophobic part. Further, in a construction that meets Equation (2) described above, the lyophobic part can constitute a super-liquid-repellent surface. In the embodiments below, a structural body will be described in which liquid repelling portion is formed on the surface of substrate 101 as a lyophobic part.

### FOURTH EMBODIMENT

In the present embodiment, description will be given of an example in which a structural body having a liquid repelling portion is applied to an electrode for a fuel cell which uses an electrolytic solution as an electrolyte.

FIG. 13 is a plan view schematically showing the structure of a fuel cell electrode according to the present embodiment. Electrode 200 shown in FIG. 13 has a porous conductive carbon substrate 201, groove-like flow channel 205 formed in conductive carbon substrate 201, fuel supply hole 208 formed at one end of flow channel 205 so as to penetrate conductive carbon substrate 201, and fuel exit hole 209 formed at the other end of flow channel 205 so as to penetrate conductive carbon substrate 201. A gas fuel is supplied to flow channel 205 through fuel supply hole 208 and guided through fuel exit hole 209 to outside electrode 200.

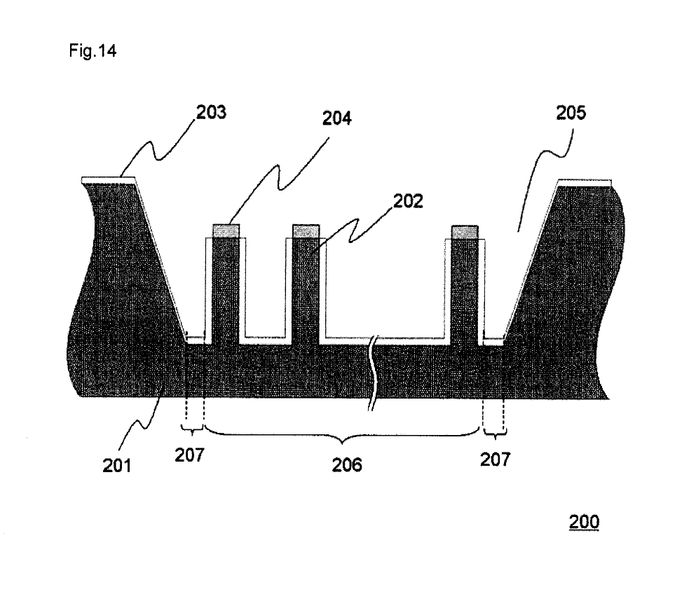

FIG. 14 is a sectional view taken along line A-A′ in FIG. 13. As shown in FIG. 14, liquid repelling portion 206 and flat part 207 formed outside of liquid repelling portion 206 are arranged in this order on conductive carbon substrate 201 in flow channel 205 of electrode 200. In liquid repelling portion 206, square pole-like pillars 202 are formed on conductive carbon substrate 201 as a recess and protrusion structure. Pillar 202 has a rectangular top surface, and the long side of which is placed along an extending direction of flow channel 205, through which a gas fuel flows; the extending direction corresponds to a direction of FIG. 14 which is farther from the reader.

Further, in the region except for the top surfaces of pillars 202, the surface of conductive carbon substrate 201 is covered with porous fluorine resin film 203 that exhibits a repellent property to predetermined electrolytic solution such as phosphoric acid. Consequently, the surface of conductive carbon substrate 201 exhibits a very high liquid repellent property together with pillars 202. This inhibits a gas moving path from being blocked by ingression of an electrolytic solution into liquid repelling portion 206. This in turn prevents a decrease in efficiency.

On the other hand, the height of pillar 202 is smaller than the depth of flow channel 205. No fluorine resin film 203 is formed on the top surface of pillar 202. Thus, in FIG. 14, only a low liquid repellent property is exhibited above pillar 202 in a direction along the extending direction of flow channel 205. This enables the electrolytic solution to flow easily in a direction of flow channel 205 and circulate.

Catalyst 204 is deposited on the top surface of pillar 202. A material for catalyst 204 is appropriately selected according to the types of fuel components in the fuel. Possible materials include, for example, metal such as platinum and a platinum-ruthenium alloy. Further, a predetermined electrolytic solution (not shown) such as phosphoric acid is disposed in contact with the surface of catalyst 204.

Electrode 200, shown in FIGS. 13 and 14, is obtained by using a fine-processing technique to form flow channel 205 and pillars 202 on conductive carbon substrate 201. However, liquid repelling portion 206 has a special recess and protrusion shape that meets conditions for reliably removing the liquid. Accordingly, such a recess and protrusion structure needs to be formed on conductive carbon substrate 201. It is thus difficult to obtain such a construction simply by roughening the surface of conductive carbon substrate 201 or forming plural pillars 202 on conductive carbon substrate 201.

In electrode 200, pillars 202 are each shaped to have a large surface area and are closely disposed in the region of liquid repelling portion 206. This makes liquid repelling portion 206, consisting of the recess and protrusion structure, sufficiently liquid repellent to reliably exclude the liquid. For example, the first to third embodiments and aspects according to examples described below are applicable to the shape and arrangement of pillars 202 in liquid repelling portion 206. This makes it possible to reliably inhibit the liquid from leaking from flat part 207 to liquid repelling portion 206.

For example, in liquid repelling portion 206, the liquid repellent property may vary depending on the direction as described above. For example, liquid repelling portion 206 may have plural rows arranged parallel to one another in each of which plural pillars 202 of a substantially identical shape are arranged. Further, the width of top surface of pillar 202 in the extending direction of the rows may be different from that in a direction perpendicular to the extending direction.

Further, in liquid repelling portion 206, pillars 202 may be arranged like a matrix or in oblique matrix form, for example, in staggered form.

Equations (1) and (2) shown above are also applicable to liquid repelling portion 206. Controlling the surface area of the recess and protrusion structure enables the level of the lyophobic property or liquid repellent property to be adjusted. Further, |α cos θ|>1 enables liquid repelling portion 206 to be made super-lyophobic.

Electrode 200 shown in FIGS. 13 and 14 is used as a fuel electrode of a fuel cell that uses an electrolytic solution as an electrolyte. In this case, the electrolytic solution or a matrix containing the electrolytic solution is disposed on the surface on which the flow channel 205 is formed, that is, in the upper part of FIG. 14. An oxidizer electrode is then disposed opposite electrode 200 via the electrolytic solution.

In electrode 200 of fuel cell configured as described above, when a hydrogen-containing gas is supplied to fuel 205, a fuel component such as hydrogen is decomposed above pillars 202 by catalyst 204 to generate hydrogen ions. The hydrogen ions migrate to the electrolytic solution or the matrix containing the electrolytic solution. Further, a gas is emitted to outside the electrode 200 via liquid repelling portion 206.

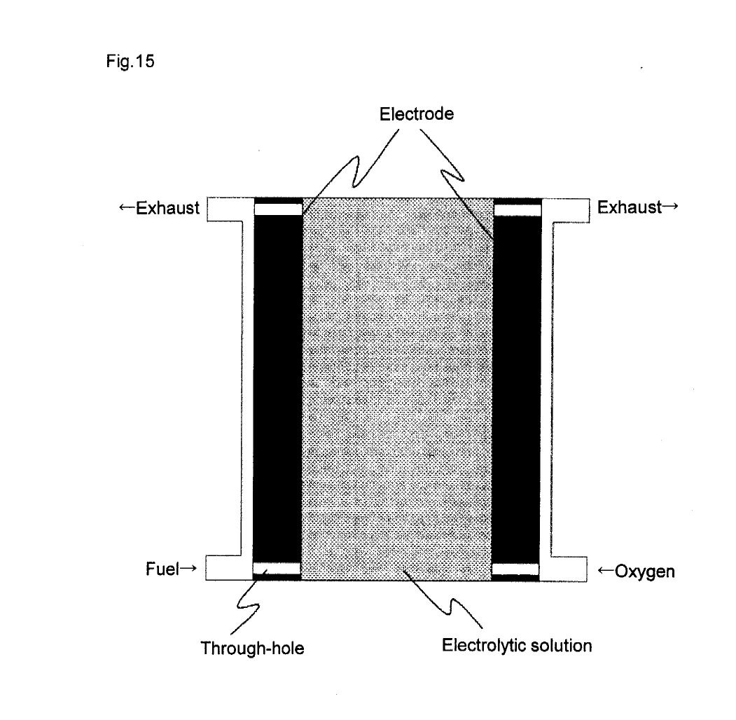

The fuel cell electrode shown in FIG. 14 provides a path through which a gas fuel moves, and inhibits the migration of the gas from being blocked by the liquid. The electrode can thus be preferably used for, for example, phosphoric fuel cells. FIG. 15 is a sectional view schematically showing the exemplary structure of a fuel cell in which electrode 200 is used.

Further, FIG. 13 illustrates meandering flow channel 205 but the shape of flow channel 205 may be arbitrarily selected.

The embodiments of the present invention have been described with reference to the drawings. However, these embodiments are only illustrative and various other components can be employed.

For example, in the descriptions of the first and second embodiments, the structural body having the liquid retaining portion is used as a reservoir. However, the liquid retaining portion may be a flow channel for liquid. For example, the structural body may be composed of a flow channel formed in the surface of the substrate so as to extend in a predetermined direction and a liquid retaining portion formed in the vicinity of at least one end of the flow channel. Alternatively, the liquid retaining portion may be formed from the vicinity of one end to the vicinity of the other end of the flow channel.

Further, a liquid flow channel may be formed on the substrate, and a reservoir which is in communication with the flow channel and consists of the structural body described in the first or second embodiment may be formed at an end of the flow channel. In this case, the reservoir consisting of the structural body according to the above embodiments may be preferably used for a sample introducing portion through which a liquid sample is introduced into the flow channel, a liquid collecting portion in which a liquid having flowed through the flow channel is collected, or the like.

Further, the structural body described in the above embodiments can be used to control the lyophilic/lyophobic property of the surface of the substrate to control the ratio of specific surface area of the liquid retaining portion consisting of the structural body to the area of the liquid retaining portion. Therefore, the lyophilic/lyophobic property can be reliably controlled using the simple construction.

### EXAMPLES

### Example 1

FIG. 6 is a plan view schematically showing the construction of a chip according to the present example. As shown in FIG. 6, in the present example, flow channel 111 of 100 μm width which is often used in biochips was formed on substrate 112. The etching depth of flow channel 111 was varied to compare the speed at which pure water flowed into flow channel 111.

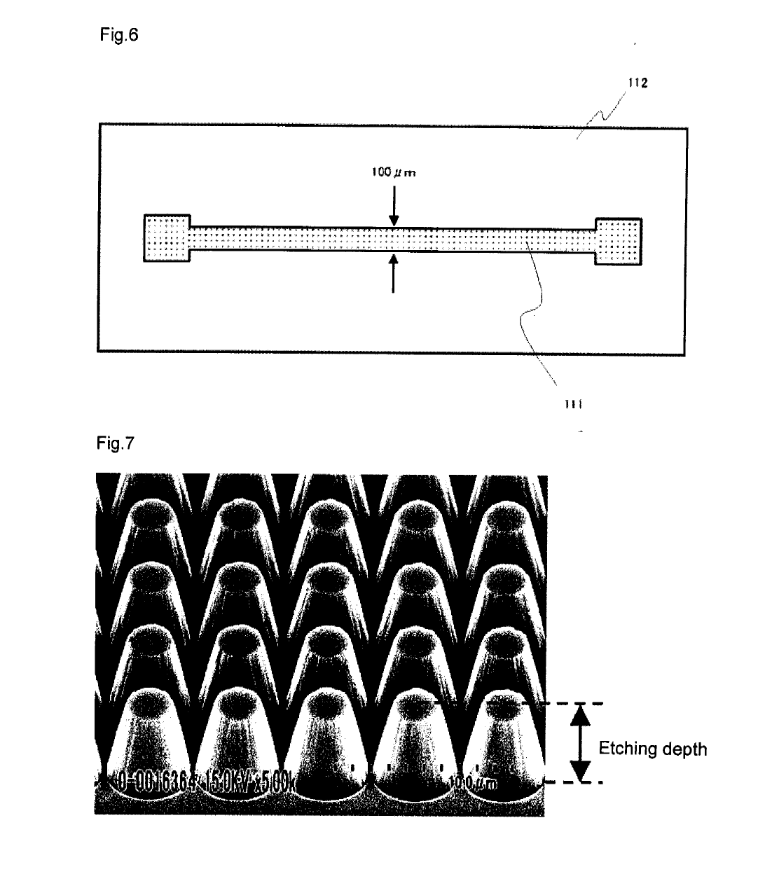

A silicon or quartz substrate was used as substrate 112. If a silicon substrate is used as substrate 112, after etching, the surface of substrate 112 was thermally oxidized to form a silicon oxide film to make the entire surface lyophilic. A mask pattern with 2.5-μm dots and gaps was used to etch a region constituting flow channel 111, while forming a recess and protrusion structure throughout the flow channel 111; the structure is shaped like projections consisting of truncated cones shown in FIG. 7. FIG. 7 is a diagram showing an SEM (scanning electron microscope) image of flow channel 111.

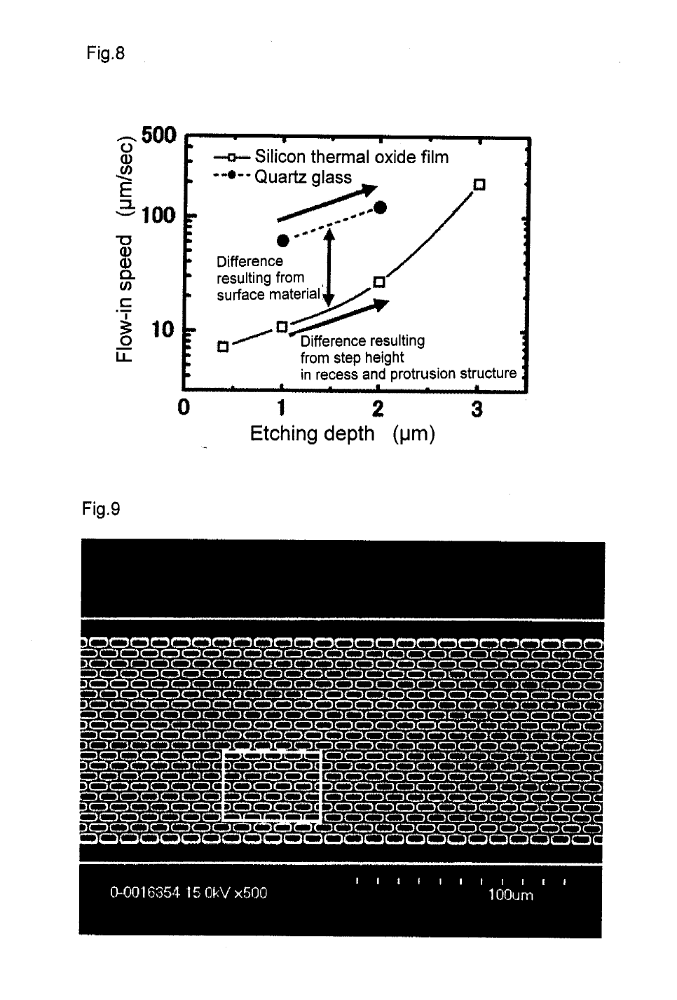

FIG. 8 is a diagram showing results for the speed at which pure water flowed into flow channel 111. In FIG. 8, the axis of abscissa indicates the etching depth, corresponding to a difference in height in the recess and protrusion structure. The axis of ordinate indicates the speed at which typical lyophilic pure water flowed into the flow channel. In this case, the recess and protrusion structure was sufficiently deep and value α was large. This allows the provision of a super-hydrophilic property with which value α cos θ exceeds 1. Thus, no droplets were formed and the hydrophilic property could not be evaluated on the basis of the contact angle. Further, the contact angle of surface of substrate 112 in the flat part around the outer periphery of flow channel 111 was 16°; the surface was hydrophilic. This indicates that the formation of the recess and protrusion structure enhanced the hydrophilic property.

Further, also with a silicon substrate, increasing the etching depth to 0.4, 1.0, 2.0, and 3.0 μm in this order increased the flow-in speed and enhanced the hydrophilic property. That is, the hydrophilic property can be controlled by the difference in height. Increasing the difference in height makes it possible to increase the level of the hydrophilic property.

Further, also with a quartz glass substrate, increasing the difference in height from 1.0 to 2.0 μm enhanced the hydrophilic property. Quartz glass belongs to silicon oxide in a physical sense but exhibits a more significant hydrophilic property than a silicon substrate owing to differences in production conditions. However, for the quartz glass and silicon substrates, the inclinations of the increases in hydrophilic property level are almost parallel to each other because they have the same structure in spite of the above differences.

These results indicate that when a liquid retaining portion is formed which consists of a recess and protrusion structure and which extends from the vicinity of one end to the vicinity of the other end of a flow channel, a region of a substrate surface in a chip which has different lyophilic/lyophobic property levels in spite of an identical surface treatment or coating can be controlled to selectively introduce a liquid into the flow channel and to retain the introduced liquid in the flow channel.

### Example 2

In the present example, the shape and surface arrangement of pillars in FIG. 6 were changed to produce a chip having flow channel 111 with a different recess and protrusion shape. The width of bottom surface of the pillar in the extending direction (longitudinal direction) of flow channel 111 was larger than that in a direction (latitudinal direction) perpendicular to the extending direction of flow channel 111, that is, 2.5 μm on a mask layout. Further, the spacing between the bottom surfaces of the adjacent pillars in the latitudinal direction was 2.5 μm on the mask layout. The gap between the adjacent pillars was sufficiently smaller than the width of the bottom surface in the latitudinal direction.

Further, the width of top surface of the pillar in the extending direction of the flow channel was larger than that in the direction perpendicular to the extending direction. Furthermore, the length of ridge of the recess and protrusion structure in a cross section that is parallel to the extending direction of the flow channel and perpendicular to the flat surface with respect to the length of the liquid retaining portion in that cross section was larger than the length of ridge of the recess and protrusion structure in a cross section that is perpendicular to the flat surface with respect to the length of the liquid retaining portion in that cross section. Moreover, the region between the two adjacent pillars in the latitudinal direction was not formed on a straight line, and the pillars were arranged in checkered pattern form so as to constitute a zigzag arrangement.

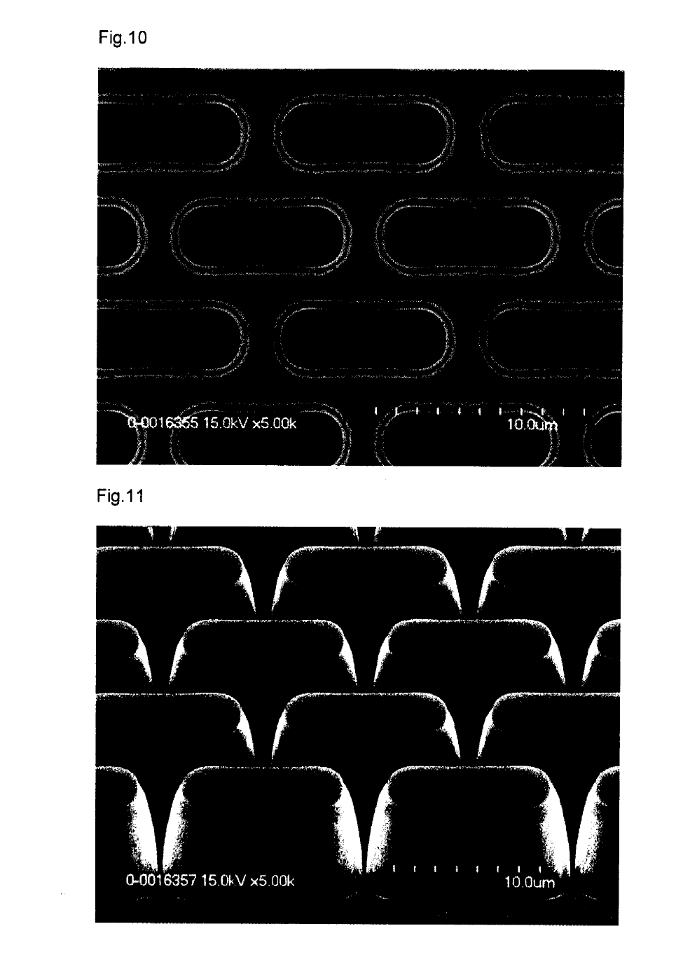

This chip can be stably manufactured at a high yield by means of etching. FIG. 9 is a top view showing an SEM image of a produced chip. FIG. 10 is an enlarged diagram of a part of FIG. 9 enclosed by a rectangular frame. Further, FIG. 11 is a perspective view showing an SEM image of the same region of FIG. 10. When pure water was introduced into the chip obtained, the introduction was quickly achieved and the liquid was preferably inhibited from leaking from the side of flow channel 111.

### Example 3

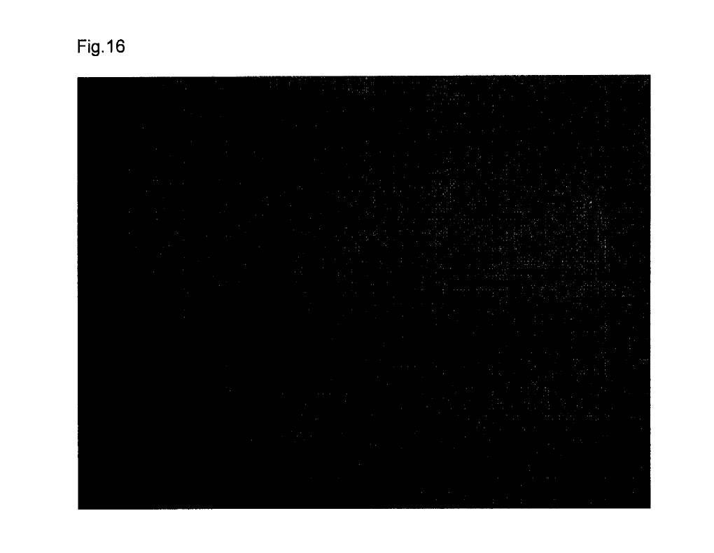

The present example shows a radial pattern formed as an example of a regular recess and protrusion structure as shown in FIG. 16. In the present example, a dry etching technique was used to form a pattern with a difference in height of 10 micron on a glass substrate. The diameter of a circle located at the center of the radial pattern may be appropriately selected. In this case, the diameter was 200 micron. In this radial pattern, the difference in height Ah of the recess and protrusion structure had a fixed value of 10 micron in a cross section traversing radial patterns arranged at the intervals of center angle (2π/N), for example, an a-a′ cross section. In this case, in each radial pattern, in a fine region with a small width 8r on a circumference of a radius r from the center, the surface areas of the step and flat parts can be approximately expressed by δr×Δh and δr×r×(2π/N), respectively. In a direction from an outer peripheral part to a central part, the radius r from the center decreases to reduce the surface area of the flat part: δr×r×(2π/N), with the surface area of the step part: δr×Δh remaining fixed. In other words, in the direction from the outer peripheral part to the central part, the multiplication factor resulting from the recess and protrusion structure with the fixed difference in height: α=1+(Δh/{r×(2π/N)} increases.

Since the glass substrate surface is hydrophilic, the contact angle θ of water on a flat surface is 0<θ<90°. In this radial pattern, an increase in the multiplication factor of the surface area: α toward the circle located in the center increases cos θr, given by Equation (1) cos θr=α cos θ. That is, the apparent contact angle θr decreases to increase the effective hydrophilic property level toward the circle located in the center of the radial pattern.

When this radial pattern is used as a recess and protrusion structure formed on the surface, since the recess and protrusion structure is generally rotationally symmetric with respect to the center axis, the multiplication factors of the surface areas along two linear axial directions defined with the center axis set as a start point exhibit a symmetry that satisfies the rotational symmetry. On the other hand, when the axial start point is set at a point eccentric to the center axis, for example, on a segment shown by a-a′ in FIG. 16, and the two axial directions defined on the surface are a positive directional axis and a negative directional axis extending in a direction opposite to that of the positive directional axis, that is, toward the outer periphery, the multiplication factor of the effective surface area along the positive directional axis is different from that of the effective surface area along the negative directional axis. That is, when the multiplication factor α+ of the effective surface area along the positive directional axis toward the center axis is compared with the multiplication factor α− of the effective surface area along the negative directional axis toward the outer periphery, α₊>α₋. Relationship α₊>α₀>α₋ is established between the multiplication factor α₀ of the effective surface area at the start point eccentric to the center axis and a+ and α−, which correspond to the multiplication factors of the local surface areas at remote positions in the respective axial directions, the positive and negative directions. Additionally, difference (α₊−α₋) increases consistently with the distance between the two axially remote positions.

The surface with the radial pattern enables the aqueous solution sample to be concentrated while concentrating the radial pattern in the central part. A droplet of the aqueous solution sample to be concentrated, that is, an aqueous solution containing the sample dissolved into an aqueous solvent as a solute, is dropped onto the pattern. The droplet is targeted at the center of the radial pattern. However, a droplet showing a generally circle outer peripheral part is often formed on the pattern, with the center of the droplet located at a position slightly eccentric to the center. For example, the aqueous solvent is dried starting with the droplet formed at the slightly eccentric position. Then, the diameter of outer peripheral part of the droplet decreases consistently with the amount of the liquid. On this occasion, the shape of outer peripheral part of the droplet, which varies with decreasing liquid amount, is affected by the hydrophilic property level or anisotropy resulting from the recess and protrusion structure on the surface of the radial pattern. In this case, on the surface of the radial pattern, the effective hydrophilic property level increases toward the center of the surface. Accordingly, the outer peripheral part of the droplet of the aqueous solvent starts contracting toward the center of the radial pattern, which exhibits a high effective hydrophilic property level. Consequently, as the droplet is dried, which was eccentric to the center of the radial pattern, its outer peripheral part contracts so that the center of the radial pattern aligns with the center of the droplet. As the droplet is further dried, its liquid amount is sharply reduced and its final form fits the circle located in the center of the radial pattern. At this time, the solute dissolved into the droplet, that is, the sample, is deposited within the circle located in the center of the radial pattern in which the droplet in the slight amount is present. Therefore, although the initial droplet shape with the large diameter is centered at the position slightly eccentric to the center, the sample contained in the droplet is finally concentrated and deposited within the center circle after drying.

The radial pattern shown in FIG. 16 was actually experimented. Pure water was dropped so that the center of the droplet was slightly eccentric, and a variation in droplet shape caused by water evaporation was observed. As the evaporation progressed, the remaining fine droplet of pure water was shaped to fit the circle located in the center of the radial pattern. The droplet was finally dried up. The pattern of a variation in droplet shape caused by the evaporation of the aqueous solvent produces effects similar to those of an anchor chip commercially available from Bruker Daltonics. This anchor chip is used as a target plate for a laser desorption ionization time-of-flight mass spectroscope. The anchor chip is effective in concentrating an aqueous solution sample such as peptide or protein which has been dropped onto the chip. The sample solution dropping portion of the anchor chip has a hydrophilic region of diameter several hundred microns in its center; the periphery of the hydrophilic region is surrounded by a hydrophobic region. An aqueous solution containing peptide or protein is dropped onto the dropping portion. Then, during dehydration, the solution is shaped so as to cover the central hydrophilic region of diameter several hundred microns. Finally, the sample from the concentrated solution is deposited on the surface of the hydrophilic region. It is well known that owing to this concentration effect, using this anchor chip for mass spectroscopy enables the sample to be very sensitively detected by irradiating the central hydrophilic region of diameter several hundred microns with laser.

The radial pattern in the present example also allows the sample to be deposited in the central circle in a concentrated manner, exerting effects similar to those of the anchor chip. On the other hand, the radial pattern in the present example eliminates a coating process of forming a separate hydrophilic and hydrophobic regions as in the case of the anchor chip. In general, surface coating is fragile and has its surface condition degraded after plural times of use. On the other hand, the radial pattern in the present example utilizes the recess and protrusion pattern formed on its surface to produce effects similar to those of the anchor chip, which utilizes surface coating. Further, the recess and protrusion pattern formed on the surface has its surface condition degraded less significantly than the surface coating. Moreover, when the chip material forming the radial pattern is glass, the glass material itself sufficiently resists chemicals that are used for, for example, sequencing based on Edman gas phase degradation of peptide or protein starting with an N terminal side or gas phase degradation starting with a C terminal side. Accordingly, the radial pattern can be used for an application described below. An aqueous solution of a sample, isolated polypeptide or protein, is dropped on a glass chip on which a radial pattern has been formed. The solution is then dried so that the polypeptide or protein is concentrated and deposited in the center of the radial pattern. The whole target plate holding the dried polypeptide or protein in its center is subjected to the above gas phase degradation. The degradation product present in the center is then subjected to mass spectroscopy. An N terminal amino acid sequence or a C terminal amino acid sequence is then formed.

Of course, even with the radial pattern in the present example, to produce a higher concentration effect, the inside of the circle in the central part of the radial pattern may be made hydrophilic, while the radial pattern may be made insignificantly hydrophilic. The central part of the radial pattern need not necessarily be circular but may be shaped like a convex polygon such as a hexagon or rectangle provided that the area of the convex polygon is equivalent to that of the circle. Alternatively, a desired shape may be used provided that it exhibits an area/outer periphery ratio equivalent to that of the convex polygon.

On the other hand, with the recess and protrusion structure of the radial pattern, utilized in order to increase the surface area, the multiplication factor α of the surface area can be increased from the peripheral part to the central part not only for a fan-shaped radial pattern but also, for example, a radial pattern in which pattern side walls spread spirally.

Further, various shapes may be selected for each radial pattern itself, not only the fan shape, in which the inner and outer peripheries correspond to circular arcs of concentric circles, but also a shape in which the inner and outer peripheries correspond to parts of outer peripheries of concentric hexagons or the shape of the pattern itself may correspond to a trapezoid.

1. (canceled)

2. (canceled)

3. A structural body formed on a surface of a chip on which a liquid is manipulated, characterized in that
the structural body being composed of a regular recess and protrusion structure formed on a surface of the chip which contacts the liquid,
wherein
the regular recess and protrusion structure formed on the surface of the chip is constructed by regularly arranging a plurality of pillars formed on the surface of the chip,
the regular recess and protrusion structure comprising the plurality of pillars formed on the surface of the chip has such a construction that a plurality of rows, each of which is composed of a plurality of truncated cone-shaped pillars of a substantially identical shape being arranged on a straight line, are arranged parallel to one another, and
in the two axial directions defined on the chip surface in directions parallel and perpendicular to the straight line,
when a local multiplication factor of a surface area along each of the axial directions is defined, for a local area being defined along the direction of the axis, as the ratio of total surface area including the surface of the regular recess and protrusion structure and the chip surface which are included in the local area to the area which is included in the local area being located on the chip in which the regular recess and protrusion structure is formed,
the local multiplication factor of a surface area along each of the axial directions varies along the two axial directions.

4. A structural body as claimed in claim 3, wherein in the construction in which the plurality of rows, each of which is composed of a plurality of truncated cone-shaped pillars being arranged on the straight line, are arranged parallel to one another,
relative positions are selected for the pillars arranged on adjacent rows so as to prevent the pillars from being aligned in a straight line in the axial direction perpendicular to the straight line.

5. A structural body as claimed in claim 4, wherein in the construction in which the plurality of rows, each of which is composed of a plurality of truncated cone-shaped pillars being arranged on the straight line, are arranged parallel to one another,
positions for the pillars being arranged on adjacent rows are selected in such a manner that relative positions between the pillars being arranged in different rows composes a checkered pattern arrangement.

6. A chip having a surface on which a liquid is manipulated, characterized in that:
a flow channel for the liquid is set up on the chip surface, and
at least a part of surface of the flow channel for the liquid comprises the structural body as claimed in any of claims 3 to 5.

7. A chip having a surface on which a liquid is manipulated, characterized in that;
a plurality of reservoirs for the liquid are set up on the surface of the chip, and
at least a part of surface of the plurality of reservoirs for the liquid comprises the structural body as claimed in any of claims 3 to 5.

8. A method of controlling a lyophilic/lyophobic property, with respect to a liquid, of a surface of at least a partial region of a surface of a chip on which the liquid is manipulated, the method being characterized in that:
the lyophilic/lyophobic property with respect to the liquid is controlled by constructing the surface of the region using the structural body as claimed in any of claims 3 to 5.

9. A structural body formed on a surface of a chip on which a liquid is manipulated, characterized in that
the structural body being composed of a regular recess and protrusion structure formed on a surface of the chip which contacts the liquid,
wherein
the regular recess and protrusion structure provided on a surface of the chip is constructed by regularly arranging a plurality of recess and protrusion structures comprising radial patterns that are formed on the surface of the chip.
